(19) United States
(12) Patent Application Publication
(10) Pub. No.: US 2024/0053995 A1
(43) Pub. Date: Feb. 15, 2024

(54) METHOD FOR CREATING A MENU STRUCTURE ON A MEASURING TRANSDUCER OF PROCESS AUTOMATION TECHNOLOGY

(71) Applicant: Endress+Hauser Conducta GmbH+Co. KG, Gerlingen (DE)

(72) Inventors: Stefan Kempf, Kornwestheim (DE); Stefan Robl, Hünxe (DE)

(21) Appl. No.: 18/448,543

(22) Filed: Aug. 11, 2023

(30) Foreign Application Priority Data
Aug. 11, 2022 (DE) 10 2022 120 352.2

(51) Int. Cl. G06F 9/451; G06F 3/0482

(52) U.S. Cl. CPC G06F 9/451; G06F 3/0482

(57) ABSTRACT

A method for creating a menu structure on a measuring transducer of process automation technology includes a step of transmitting an app to the measuring transducer, wherein the firmware of the measuring transducer is designed to receive and store apps. The app comprises at least program code with an app-specific menu structure, and the app-specific menu structure comprises at least one root page as the top hierarchical menu page. The method also includes combining the app-specific menu structure with a measuring-transducer-specific menu structure to form a common menu structure. The measuring-transducer-specific menu structure is located in the measuring transducer and uses a placeholder comprising one or more anchor points, wherein the placeholder defines where the app-specific menu structure is integrated into the measuring-transducer-specific menu structure. The anchor point comprises a reference to the root page and the entire app-specific menu structure is integrated below the latter.

### CROSS-REFERENCE TO RELATED APPLICATION

The present application is related to and claims the priority benefit of DPMA Patent Application No. 10 2022 120 352.2, filed on Aug. 11, 2022, the entire contents of which are incorporated herein by reference.

### TECHNICAL FIELD

The present disclosure relates to a method for creating a menu structure on a measuring transducer of process automation technology. The present disclosure further relates to a measuring transducer for implementing the method.

### BACKGROUND

Generally speaking, a measuring transducer, also called a transmitter, is a device that converts an input variable into an output variable according to a fixed relationship. In process automation technology, a field device, for example, is connected to a measuring transducer. “Measuring transducer” and “transmitter” are used synonymously herein. The field device is a sensor, for example. Its raw measured values are processed in the measuring transducer, e.g., averaged or converted by means of a calibration model to another variable, for example, the process variable to be determined and possibly transmitted, to a control system, for example.

The most varied sensors can be connected to the measuring transducer. Under the aforementioned name, “Memosens,” the applicant markets sensors for measuring pH value, conductivity, oxygen, turbidity, and other things. The measuring transducer can also be an integral part of the sensor.

The field device connected to the measuring transducer, i.e., the sensor, for example, is parameterized, and other settings are changed via the measuring transducer. For this purpose, the measuring transducer has a display and possibilities for making entries, e.g., via buttons, switches, touch display or via external devices that are connected to the measuring transducer via a wireless or wired interface (such as USB, serial or parallel interface, RS-232, Bluetooth, etc.).

An appropriate menu is displayed on the display. In the sense of the present application, the term, “menu structure,” is used. The menu structure comprises the entirety of all menu pages and the navigation therein. The menu structure thus describes the hierarchy, navigation, and texts of the various menu pages that are shown on the display of the measuring transducer, in order to guide the user. The menu structure allows for selecting from an offering and manipulating or executing a desired setting or a command. Adjustments, both on the measuring transducer and for the field device connected thereto (for example, the sensor), are made via the menu structure.

Measuring transducers generally cover a multiplicity of applications and various connectable sensors. As a consequence, the menu structure of the measuring transducers is kept very generic. For users, this has the disadvantage that they must first find their way around the menu structure for their specific application and possibly also for the specific sensor. The items actually relevant to the application or the sensor are scattered in the menu of the measuring transducer, i.e., the “measuring-transducer-specific menu structure,” and hidden under a multiplicity of other menu items that are irrelevant to the application or the desired sensor.

### SUMMARY

The present disclosure is directed to making the menu structure of a measuring transducer for applications and sensors easier for the user or to provide a menu structure that is tailored to the respective application or the respective sensor.

The disclosure is described with reference to method, according to claim 1, and a measuring transducer, according to claim 15.

Specifically, the object is achieved by the method comprising the steps of: transmitting an app to the measuring transducer if the app is not yet located on the measuring transducer, wherein the firmware of the measuring transducer is designed to receive and store apps; wherein the app comprises at least program code with an app-specific menu structure, wherein the app-specific menu structure comprises at least one root page as the top hierarchical menu page; and combining the app-specific menu structure with a measuring-transducer-specific menu structure to form a common menu structure, wherein the measuring-transducer-specific menu structure is located in the measuring transducer, by means of a placeholder comprising one or more anchor points, wherein the placeholder defines where the app-specific menu structure is integrated into the measuring-transducer-specific menu structure, wherein the anchor point comprises a reference to the root page and the entire app-specific menu structure is integrated below the latter.

In the following, the term “app” is used synonymously with the term “plug-in” and is a downloadable program code which brings a useful functionality.

A menu page is a collection of elements that can be static texts, parameters, or links to other menu pages.

A placeholder comprises a dynamically changing collection of anchor points. A placeholder is located within the measuring-transducer-specific menu structure. A placeholder defines “where” the app-specific menu structure or subpages is/are mounted.

An anchor point is a tuple consisting of title and reference to another complete menu page, such as, a root page. An anchor point is thus a submenu item that appears instead of the placeholder and the selection of which leads the user to another menu page. Which anchor points a placeholder specifically contains depends on the apps installed on the measuring transducer. The anchor point thus specifies “which” app-specific page is to be included in place of the placeholder.

A root page is the top page in the hierarchical menu structure of an app. Below this root page, there are further menu pages of the app. An app may also comprise a plurality of root pages. A placeholder contains anchor points only if there are root pages that are suitable for the placeholder. Otherwise, the placeholder is invisible.

A placeholder contains one or more anchor points if there are one or more root pages that are suitable for the placeholder. In this case, the placeholder can be presented, for example, as a list of the titles of the anchor points. When clicking “on the anchor point,” i.e., on the title, a jump to the referenced root page takes place. The title may, for example, correspond to the name of the app or to the page title of the root page.

One embodiment provides that the anchor point is designed as a tuple comprising a title, such as, the page title of the root page or the title of the app, and a reference to the root page.

One embodiment provides that a root page is displayed directly after the start of the measuring transducer.

One embodiment provides that the app comprises metainformation, such as, about properties of the root page.

One embodiment provides for the metainformation to declare a root page as a home page.

The claimed structure makes it possible for the app-specific menu structure to “replace” the measuring-transducer-specific menu structure. It is thus possible to significantly adapt the measuring transducer to the respective application. Of course, the measuring-transducer-specific menu structure has not disappeared but is (initially) not visible or even accessible to the user. The app-specific menu structure, however, comprises the option of switching into the measuring-transducer-specific menu structure, i.e., the app-specific menu structure has an “exit option.” Likewise, the measuring-transducer-specific menu structure has an “exit option” or a switch to the app-specific menu structure can take place via the placeholder and anchor point.

In one embodiment, the app-specific menu structure, such as a root page, such as a root page marked by corresponding metainformation (see below), is thus called directly after the boot process of the measuring transducer, viz., advantageously without the user having to go directly into the app or having to go via the measuring-transducer-specific menu structure.

This can be understood using the example of a swimming pool controller. A user requires this application and the underlying measuring transducer is used only for this application. In this case, after application of the operating voltage (“boot process”), the swimming pool controller menu structure is basically to appear immediately. The menu structure of the actual measuring transducer is then only reached at all by (temporarily) leaving the app-specific menu structure. It is likewise conceivable that the app does not define an “exit” point for this purpose. In this case, the app (as long as it is not itself deactivated via the app menu structure) assumes the entire adapted control of the measuring transducer, and the measuring-transducer-specific menu structure is in this case suppressed.

One embodiment provides that the measuring transducer mounts the app-specific menu structure on the basis of the metainformation to a particular location in the measuring-transducer-specific menu structure.

One embodiment provides that the app-specific menu structure comprises an explicit reference to the measuring-transducer-specific menu structure, and a jump from the app-specific menu structure into the measuring-transducer-specific menu structure is thus enabled.

One embodiment provides that a switch can take place from the app-specific menu structure, or an app-specific menu structure in the presence of a plurality of app-specific menu structures, into the measuring-transducer-specific menu structure or into another app-specific menu structure and in each case back, wherein the respective exit point is temporarily stored and the switch back takes place exactly to this location.

It is thus possible to realize multitasking of the apps, or of the menu structures thereof, and the menu structure of the measuring transducer. In one embodiment, the measuring transducer comprises an operating element designed to switch back and forth between the different menu structures without actually leaving the menu structure of the (original) app (see below). Thus, instead of navigating out of the original app and explicitly switching into another app, it is noted where one is located in the menu navigations of the individual apps in order to switch back and forth.

In one embodiment, the presentation of the menu structure provided by the app is implicitly defined by a presentation unit contained in the measuring transducer, i.e., there is no explicit, separable, and thus exchangeable presentation rule in this case. The menu structure thus only describes which elements the menus contain. How these elements are presented visually is defined by the measuring transducer. The menu structure thus contains the rule of what the menu contains and is to present, but the rule of how certain menu elements are presented is fixedly pre-implemented in the measuring transducer in one embodiment.

In one embodiment, the menu structure provided by the app is presented by the app itself. In this case, the program code embedded in the app calculates the presentation suitable for the presentation system (display of the measuring transducer, web server, Bluetooth system). For example, in the case of a display, the program code of the app would calculate a pixel graphic which is presented on the measuring transducer.

In one embodiment, user inputs (e.g., via the operating elements of the measuring transducer) are forwarded to the app since the interaction with the presented menu content is likewise controlled by the app program code. There is thus an interaction between the menu system of the measuring transducer and the app. The behavior of an input element for a parameter is realized, completely, by the app itself. One example is that the user edits a parameter: The changed value must be communicated to the app since the input would otherwise be pointless. The recalculation of the image content is assumed by the menu system of the measuring transducer. In one embodiment, complete interaction between the input system (operating elements, soft keys, buttons, navigator, touchscreen, . . . ) and the app takes place. In this case, the recalculation of the image content is realized by the app itself.

One embodiment provides that the measuring transducer provides interfaces, whereby the app presents the app-specific menu structure on a display of the measuring transducer.

In one embodiment, the measuring transducer provides interfaces for common menu elements, such as texts, input fields, values of parameters, etc. This embodiment comprises pure data contents and structures. In this case, the presentation system of the measuring transducer assumes the specific drawing process in the style of the menu system provided by the measuring transducer.

In one embodiment, the measuring transducer provides, as an interface, an empty page (as a “canvas”) on which the app can draw as desired. The empty page (“canvas”) is then displayed in a subarea of the display. This offers a presentation that is left completely open, the image data of which being generated completely by the app. Examples could be special visualizations (plots) that use this advantageously.

A combination of the two is also possible.

In one embodiment, the menu structure depends upon the state of referenced parameters. Certain elements of the menu structure are thus only displayed if, for example, a certain parameter has a certain value. An example in this respect is the visibility of a set value that is required only in a certain operating mode of the field device.

One embodiment provides that the measuring transducer comprises a plurality of apps, wherein each app comprises its own program code with its own app-specific menu structure, wherein each app-specific menu structure is integrated under a separate anchor point.

One embodiment provides that the integration of the app-specific menu structure through the anchor point into the measuring-transducer-specific menu structure takes place on the basis of predefined criteria.

One embodiment provides that the criterion is applied on the basis of a Boolean formula.

The object is further achieved by a measuring transducer for carrying out the method as described above, comprising a data processing unit with a memory.

One embodiment provides that the measuring transducer comprises a data processing unit with a memory.

One embodiment provides that the measuring transducer comprises an operating element designed to switch back and forth between the different menu structures without actually leaving the menu structure of the app.

### BRIEF DESCRIPTION OF THE DRAWINGS

This is explained in more detail with reference to the following figures.

FIG. 1 shows a plurality of apps in the measuring transducer.

FIGS. 2a/b show embodiments of the measuring transducer.

FIG. 3 shows various pages in the menu structure.

FIGS. 4a-c show the structure of properties of root pages.

FIGS. 5a/b show the app symbolically.

In the Figures, the same features are labeled with the same reference signs.

### DETAILED DESCRIPTION

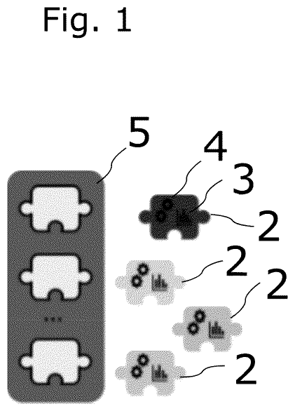

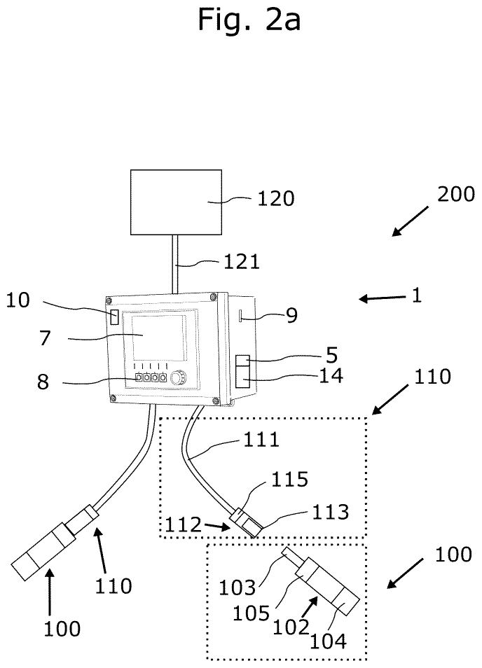

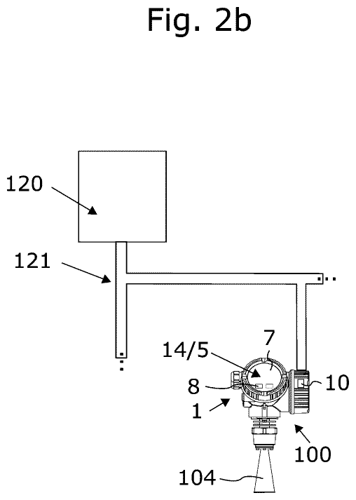

FIG. 1 shows reloadable apps 2 for a measuring transducer 1, for example with completely freely definable signal processing 3 and parameterization 4. The measuring transducer 1 comprises a data processing unit 14 with a memory 5 that is large enough to store a plurality of apps 2 (symbolized by the open regions). FIG. 1 symbolically shows the memory 5 with apps 2. FIGS. 2/b shows the measuring transducer 1.

The app 2 is thus a (re-)loadable piece of program code which offers additional functions to the measuring transducer 1.

Sensors, such as those connected to a measuring transducer 1 via a cable, often support many more applications by their measuring principle than originally supposed. For example, a turbidity sensor which was actually developed for the measurement of sludges in the field of wastewater would also be able to measure fat content in milk by using the measurement principle. In order to be able to flexibly render new applications accessible in this case, the corresponding models are not be permanently stored in the sensor but are instead reloadable in the form of apps 2.

Thus, also sensors which have already been produced are able, without a firmware update, to operate new applications. Likewise, customers who want to use their sensor for a different application can easily modify them. The ability to reload the computing models makes it possible to use highly specialized computing models which are optimized, where appropriate, only to a single measurement point. The firmware of the measuring transducer 1 is therefore designed such that it can receive apps 2 via an interface and store them internally.

It is likewise possible to make a sensor connectable to the measuring transducer 1 in the first place via an app 2 or to make it compatible in a simple manner, for example because the firmware did not yet support the sensor when the measuring transducer was delivered.

Various embodiments of the measuring transducer are possible, which FIGS. 2a/b show.

Generally speaking, a measuring transducer 1, also called a transmitter, is a device that converts an input variable into an output variable according to a fixed relationship.

The measuring transducer 1 is used in a so-called sensor arrangement 200. The sensor arrangement 200 thus comprises at least the measuring transducer 1 and a sensor 100. In FIG. 2a, the measuring transducer 1 is connected to the sensor 100 via a cable 111. The embodiments in FIGS. 2a/b have in common that the raw measured values of the sensor 100 are processed in the measuring transducer 1, e.g., averaged and/or converted by means of a calibration model into another variable, e.g., the process variable to be determined, and are possibly forwarded, for example to a control system.

First regarding FIG. 2a:

The sensor 100 comprises a first physical interface 103 via which the sensor 100 is connected to the measuring transducer 1 and thereby exchanges data (bidirectionally) and is supplied with energy (unidirectionally). The cable 111 is part of a connection element 110 which can be connected at one end to the measuring transducer 1 and at the other end to the sensor 100. At the sensor-side end, the cable 111 has a second physical interface 113 complementary to the first physical interface 103. The physical interfaces 103, 113 are configured as galvanically isolated interfaces, such as inductive interfaces. The physical interfaces 103, 113 can be coupled together by means of a mechanical plug connection. The mechanical plug connection is hermetically sealed, such that no fluid, such as the medium to be measured, air, or dust can enter from the outside.

The sensor 100 comprises at least one sensor element 104 for detecting a measured variable of process automation. Sensor 100 will then be for example a pH sensor, also known as ISFET, generally an ion-selective sensor, a sensor for measuring redox potential, the absorption of electromagnetic waves in the medium, for example with wavelengths in the UV, IR and/or visible ranges, oxygen, conductivity, turbidity, the concentration of non-metallic materials or temperature with the respective measured variable.

The sensor 100 furthermore comprises a first coupling body 102, which comprises the first physical interface 103. The connection element 110 comprises a second, cylindrical coupling body 112 that is designed to be complementary to the first coupling body 102 and can be slipped with a sleeve-like end portion onto the first coupling body 102, wherein the second physical interface 113 is plugged into the first physical interface 103.

Sensor 100 comprises a data processing unit 105, e.g. a microcontroller, which processes the values of the measured variable, e.g. converts them into a different data format. The data processing unit 105 is designed for energy and space reasons to be rather small or economical with respect to the computing capacity and the memory volume. The sensor 100 is thus designed only for “simple” computing operations, for instance for averaging, preprocessing, and digital conversion. The data processing unit 105 converts the value that depends on the measured variable (i.e., the measurement signal of the sensor element 104) into a protocol that the measuring transducer 1 can understand.

The connection element 110 may likewise comprise a data processing unit 115. The data processing unit 105 is designed to be “small” and can serve as a repeater for the data.

Several sensors 100 can also be connected to a measuring transducer 1b. Shown in FIG. 2a are two sensors 100, wherein only one of the two is provided with all of the reference signs. The same or different sensors can be connected. The left-hand one of the two is shown in the plugged-in state. Up to eight sensors, for example, can be connected to the measuring transducer 1.

The measuring transducer 1 is connected to a higher-level unit 120, such as a control system, via a cable 121. The measuring transducer 1 forwards the measured data via the cable 121 to a control system 120. In this case, the control system 120 is designed as a process control system (PLC, SPS), PC, or server. For this purpose, the measuring transducer 1 converts the data into a data format that the control system can understand, for example in a corresponding bus, such as HART, Profibus PA, Profibus DP, Foundation Fieldbus, Modbus RS485, or also an Ethernet-based field bus, such as EtherNet/IP, Profinet, or Modbus/TCP.

The measuring transducer 1 comprises a display 7 and one or more operating elements 8, e.g., knobs or rotary knobs, buttons or soft keys, via which the measuring transducer 1 can be operated. For example, measured data of the sensor 100 or the information of the app 2 are displayed via the menu structure M by the display 7. The sensor 100 can likewise be configured and parameterized via the operating elements 8 and the corresponding view on the display 7. The display 7 may also be designed as a touch display; the operating elements 8 can then also be part of the touch display, viz., as touch operating elements. The measuring transducer 1 comprises the data processing unit 14. The measuring transducer 1 may also comprise an SD card slot 9 via which apps 2 can be loaded onto the measuring transducer 1. The measuring transducer 1 may also comprise one or more wireless modules 10, such as Bluetooth, mobile radio (2G, 3G, 4G, 5G) or others, possibly also wireless bus protocols, such as WirelessHART.

The embodiment of the measuring transducer 1 in FIG. 2b differs therefrom. Sensor 100 and measuring transducer 1 are not connected to one another via a cable. Instead, sensor 100 and measuring transducer 1 form a unit. FIG. 2b shows a fill-level sensor according to the radar principle. Further principles for the fill level are guided and freely-radiating radar, as well as ultrasound, also for detection of limit level, wherein capacitive methods can also be used to detect the limit level. Further possible sensors for this embodiment are flow sensors according to the Coriolis, magnetic induction, vortex, and ultrasound principles.

Regardless of how the measuring transducer 1 is designed, the functionality can be expanded via one or more apps 2. The apps 2 are located in the memory 5. If the apps 2 are not yet in the memory 5, the app 2 will be uploaded to it. This takes place via a communication interface. Depending on the design of the measuring transducer 1, the app(s) 2 can be transmitted to the measuring transducer 1, for example via a wireless data connection (see reference sign 10), such as Bluetooth or the like. The apps 2 may also be loaded via a memory card, e.g., an SD card (see reference sign 9), into the data processing unit 14 if the measuring transducer 1 comprises such an option, see above. Likewise possible is the transmission of the app 2 via the control system 120 (via HART, WirelessHART, ModBus, Foundation Fieldbus, or others) and the corresponding wireless or wired connection line.

As mentioned, the measuring transducer 1 or sensors 100 connected thereto can be operated and parameterized via the operating elements 8. To this end, a menu or the menu structure M is presented on the display 7. The menu structure M describes the hierarchy, navigation, and texts of the various menu pages that are presented on the display 7. The menu structure M makes it possible to select the desired command from an offering and to have it executed.

The measuring transducer 1 provides parameters and settings that a user can review and change via a measuring-transducer-specific menu structure MMU in order to configure the measuring transducer 1 and the connected sensors thereof to the respective application of the user. An app 2 can offer additional parameters and settings that are relevant only to the app 2. Likewise, an app 2 may also use the parameters and settings of the measuring transducer 1 or enable changes by the user, but in an intuitive menu navigation related to the respective application of the user. Accordingly, there is an app-specific menu structure MApp.

The app 2 comprises at least program code with the app-specific menu structure MApp.

The app-specific menu structure MApp is combined with the measuring-transducer-specific menu structure MMU to form a common menu structure M. This takes place by means of a placeholder P in the measuring-transducer-specific menu structure MMU and a root page W in the app-specific menu structure MApp. The placeholder P defines where the root page W of the app-specific menu structure MApp is integrated into the measuring-transducer-specific menu structure MMU. The root page W represents the top menu page in the app-specific (hierarchical) menu structure MApp. An anchor point A is inserted into the placeholder P. At the anchor point A, a tuple consisting of title and a reference to the root page W of the app-specific menu structure MApp. The entire app-specific menu structure MApp is thus integrated under the placeholder P. An app 2 may also comprise a plurality of root pages W, said root pages W then being the same from a hierarchical perspective.

In one embodiment, the title of the anchor point A consists of the page title of the root page W. In a further embodiment, the title of the anchor point A consists of the name of the app 2.

A placeholder P can contain a plurality of anchor points A, provided there are a plurality of app-specific menu structures MApp or a plurality of root pages W. If there is no root page W that is suitable for the placeholder P, the placeholder P is invisible or not present in the common menu structure M. If there are one or more root pages W that are suitable for the placeholder P, the placeholder P contains a plurality of anchor points A. In this case, the placeholder P in the common menu structure M is expanded into a list of the titles, the anchor points A collected in the placeholder P. When the title of an anchor point A is clicked on, the menu navigates to the root page W referenced by the anchor point A.

A placeholder P is always located within the measuring-transducer-specific menu structure MMU.

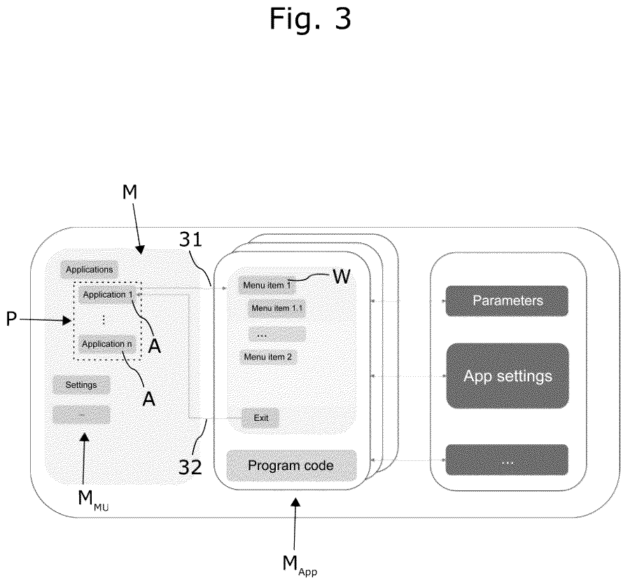

FIG. 3 shows a menu structure M. The left side shows an overview of a main page of the menu structure M. The left-justified entries, such as “applications” or “settings,” in this case represent the measuring-transducer-specific menu structure MMU. If the user clicks on one of the entries, the user is, where applicable, taken to a new page with a new selection of menu entries. In the present case, by clicking on “applications,” the user receives the selection of various specific applications. In the present case, this is “application 1” and “application n.” Of course, suitable names can be selected, such as “swimming pool,” “sewage treatment plant,” etc. The three dots ( . . . ) symbolize that more entries are possible.

The item “application 1” represents an anchor point A. The anchor point A is presented at the position of the placeholder P in the menu. The arrow 31 symbolizes that by clicking on “application 1,” the root page W of the app-specific menu structure MApp is entered. The entire app-specific menu structure MApp is located under this anchor point A. This is shown in the middle part of FIG. 3. The app-specific menu structure MApp comprises various menu entries “menu item 1” or “menu item 2,” which in turn comprise subentries, such as “menu item 1.1.” The app-specific menu structure MApp also comprises the “exit” point as a (single) return option into the measuring-transducer-specific menu structure MMU. The arrow 32 symbolizes that by clicking on “exit,” the app-specific menu structure MApp is left. The anchor point A thus represents the entry point and exit point of the app-specific menu structure (MApp).

The pages indicated parallel and symbolically behind the visible page show that a plurality of and further root page pages are arranged under the menu with root page W. The latter may belong to the same app as the top root page W, or to other apps. The right side of FIG. 3 shows options as to from which variable contents the menu structure can be fed, e.g., parameters or app settings.

The claimed method as well as the placeholder P and the anchor points A result in a central entry point instead of being “distributed” in the entire menu of the measuring transducer. If the app-specific structure is entered, only the menu of this app is navigated until the application is left (“exit”); in this case, control is again given to the menu navigation of the measuring transducer.

In this case, the measuring transducer 1 provides interfaces and functions, whereby the app 2 presents the app-specific menu structure MApp on the display 7 of the measuring transducer 1. The terms “interface” and “function” are to be understood here, below and unless otherwise indicated, as a software interface and software functions. The physical interfaces 103, 113 mentioned above, on the other hand, are designed as hardware interfaces.

The app 2 is completely free in the design of its own menu structure; it can, but need not, be built on menu elements of the measuring transducer; on the basis of appropriate interfaces offered by the measuring transducer, the app can: draw pixels directly onto the display of the measuring transducer and thus implement graphics or a completely separate menu system; build on elementary graphic functions of the measuring transducer, e.g., draw lines and rectangles; build on menu elements of the measuring transducer; and/or implement a combination of all possibilities above.

In principle, two possibilities of the presentation rule are conceivable.

The measuring transducer 1 provides interfaces for common menu elements, such as texts, input fields, values of parameters, etc. This embodiment comprises pure data contents and structures. In this case, the presentation system of the measuring transducer assumes the specific drawing process in the style of the menu system provided by the measuring transducer; ultimately, the measuring transducer decides how the data are presented. For example, the structure describes that there is a certain number and lines with a certain content. The presentation unit of the measuring transducer itself decides with which font, at which pixel coordinates, etc., these texts are presented. For example, text can also be displayed in an abbreviated manner or over several lines when it is too long for direct display.

It is likewise possible for the measuring transducer 1 to provide, as an interface, an empty page (as a “canvas”) on which the app 2 can draw as desired. The empty page (“canvas”) is then displayed in a subarea of the display. This offers a presentation that is left completely open and the image data of which are generated completely by the app. Examples could be special visualizations (plots) that use this advantageously.

A combination of the two is also possible.

A plurality of apps 2 can be executed on the measuring transducer 1, wherein each app comprises its own program code with its own app-specific menu structure MApp, wherein each app-specific menu structure MApp is integrated under a separate anchor point A within a placeholder P. It may be such that the anchor point(s) A, such as, all of them, are arranged under a single placeholder P in the measuring-transducer-specific menu structure MMU. This is shown, for example, in FIG. 3 under the item “applications,” under which all apps describing an application are combined.

In a further embodiment, the measuring-transducer-specific menu structure MMU can contain a plurality of placeholders P at different locations in the measuring-transducer-specific menu structure MMU. Thus, a meaningful thematic structure can be displayed. For example, apps with respect to sensors or measured value processing would be arranged at another location in the menu structure.

In one embodiment, the decision logic of root pages W to placeholders P is hard-coded in the measuring transducer and cannot be configured by the app.

In one embodiment, a placeholder P can contain criteria which relate to properties of the root pages W. A root page W is then assigned to the placeholder P whose properties fulfill the criteria of the placeholder P. Properties of a root page W can be stored, for example, as key value pairs in the metainformation 21 (see below) of the app 2. As mentioned, an app 2 can comprise a plurality of root pages W; these can be selected in a targeted manner on the basis of the metainformation.

A criterion for such a selection is the category of the app, i.e., for example, a specific application, a setup wizard, the category of the root page (a completely new GUI, an info page, e.g., with version info about the app, menu pages with expert settings which only admin users of the device can access, . . . ), etc. The algorithm decides in which placeholders an app page is displayed, which does not have to be permanently stored in the firmware.

The criteria of the placeholder P are generally formulated as a Boolean expression. The Boolean expression may contain variables. The name of a variable corresponds to a key of the properties of the root page W. The value of the variable corresponds to the value of the corresponding key value pair. A root page W is assigned to a placeholder P if applying the Boolean expression of the placeholder P to the properties of the root page W results in the logical value “true.” In other words, when an app 2 is loaded, the formula is applied and for the first or all placeholders P for which the result is “true,” the corresponding root page W of the app is mounted via an anchor point A. The terms in the Boolean formula can, for example, refer to metainformation 21 from the app 2.

It may be that as a result of this method, a root page W is suitable for a plurality of placeholders. Here, the following possibilities are conceivable: in one embodiment, the placeholders P receive a priority and the root page W is assigned to the placeholder P with the highest priority. In the simplest case, the priority corresponds to an automatically assigned number, e.g., the position of the placeholder in the depth-first search order of the measuring-transducer-specific menu structure MMU. In another embodiment, the developer of the measuring-transducer-specific menu structure MMU specifies the priorities of the placeholders P. Unique priorities can, for example, be ensured in the building process of the measuring-transducer-specific menu structure MMU.

In a further embodiment, the priorities are dispensed with and a root page W can be inserted into a plurality of placeholders P.

In a further embodiment, a combination is conceivable.

If a root page W is suitable for a plurality of placeholders P, the set of the placeholders P is divided into two potentially empty, disjoint sets P1 and P2. The set P1 contains placeholders P with a priority, and the set P2 contains placeholders P without a priority. The root page W is then assigned to the following placeholders P: the placeholder P with the highest priority from the set P1 if P1 is not empty; and all placeholders P from the set P2

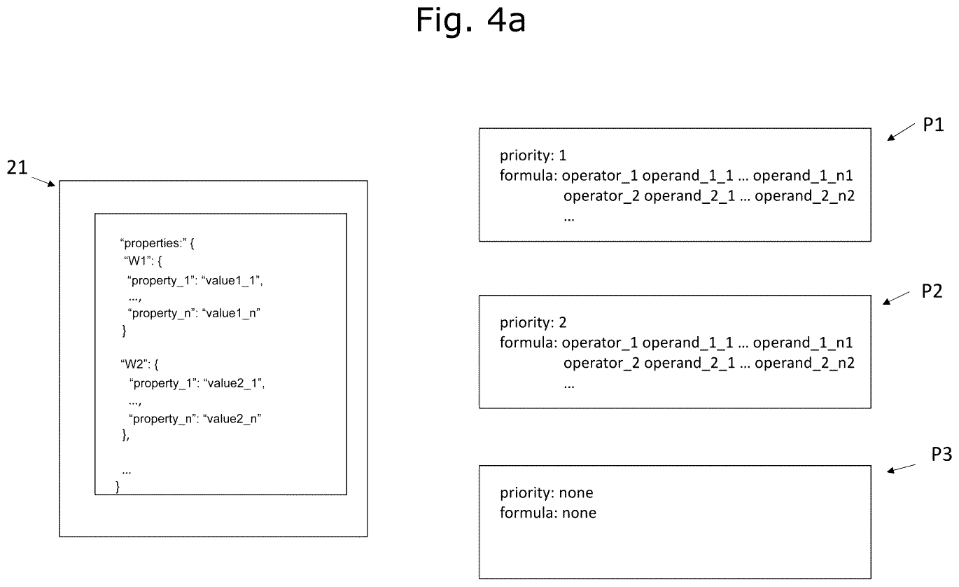

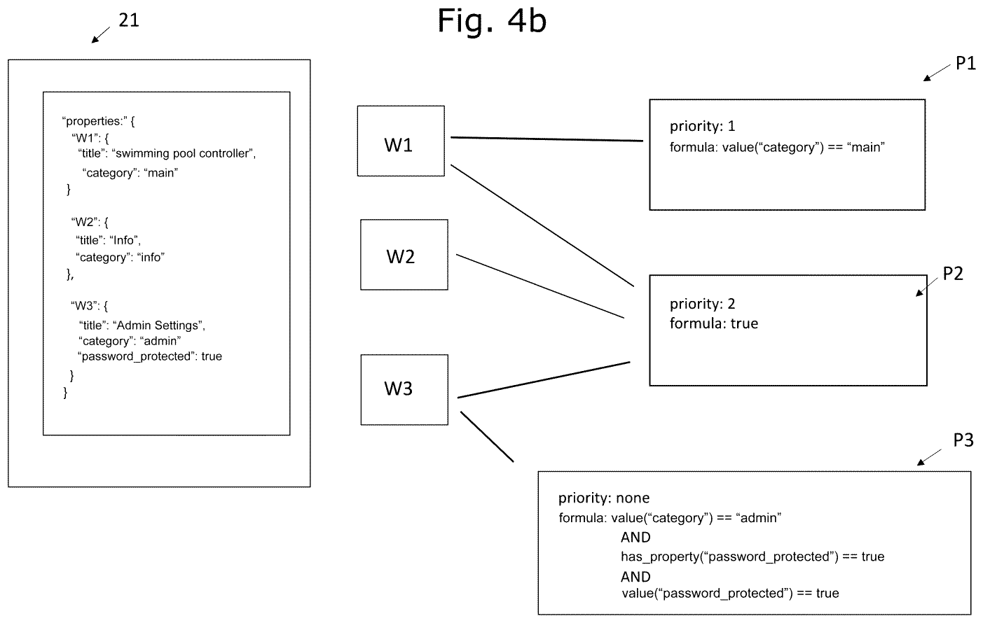

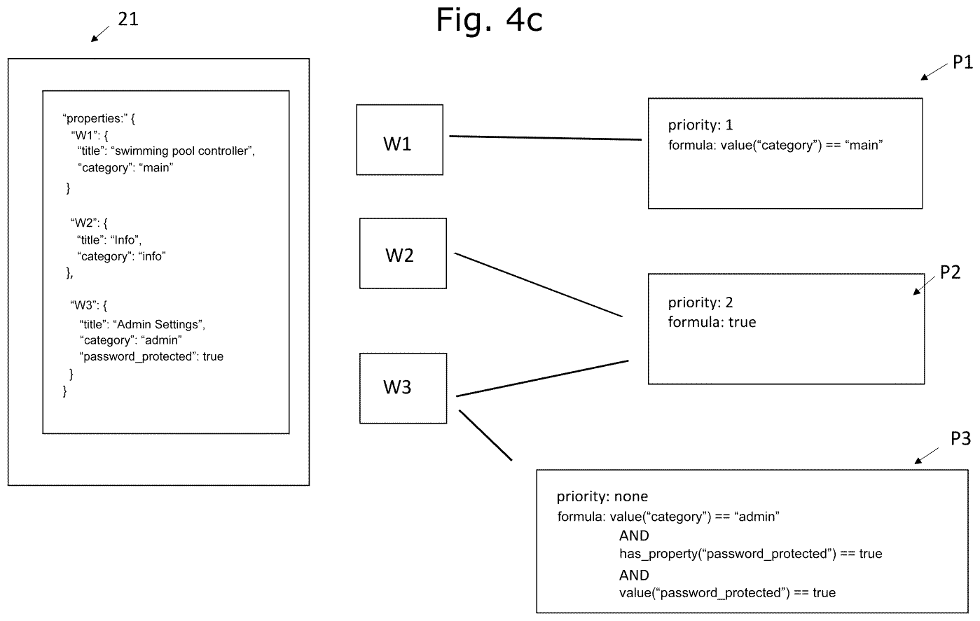

FIGS. 4a-c schematically show the structure of the properties of root pages as well as the priorities and formulas in the placeholders. The storage of the properties in the JSON format and the storage of the formulas in RPN (reverse Polish notation) are to be understood only as an example. Many further embodiments are conceivable. A different data format than JSON is likewise possible and is to be understood only as an example.

The properties of the root pages are key value pairs, wherein the key corresponds to the name of a property and the value corresponds to the value thereof. Properties may, for example, be the name of the root page or a page category. A page category indicates, for example, whether a root page represents a complete application-specific menu navigation. Likewise, for example, purely informative menu pages are also conceivable, which contain information such as version details or copyright information. Also conceivable are pages with expert settings, which are reserved for administrators of the field device.

FIG. 4a shows the metainformation 21 on the left side, wherein the inner box with the properties in the metainformation is only one of a plurality of components of the entire metainformation. A plurality of placeholders P with the reference signs P1, P2, P3 are shown on the right side. Each placeholder P1, P2, P3 has an optional priority and a Boolean formula. The formula may be stored, for example, in RPN (reverse Polish notation).

FIG. 4b shows the properties of two root pages W1, W2 and W3 on the left side. Root page W1 is the entry point into a completely application-specific GUI (“graphical user interface”) for a swimming pool controller. Root page W2 is an information page. Root page W3 is a menu page with admin settings.

A Boolean formula in a placeholder P consists of operators and operands. Operators may be logical operations, such as AND, OR, XOR, comparisons, arithmetic operators, predicates (such as whether a certain property, i.e., a key, exists for a root page W), etc. The operands may be constants, such as “true” and “false,” as well as the properties of (i.e., keys) of root pages W.

A Boolean formula in a placeholder P may be optional. In one possible embodiment, the absence of a formula ensures that a formula permanently stored in the measuring transducer is applied. In another embodiment, the absence of a formula can mean the implicit formula “true,” i.e., the placeholder is considered to be suitable for any root page.

Placeholders P likewise have an (optional) priority which is encoded, for example, as an integer, wherein a smaller value corresponds to a higher priority.

On the right side of FIG. 4b, three placeholders P together with priorities and Boolean formulas are shown, as well as the assignment of root pages to placeholders initially without consideration of the priority. For better readability, the Boolean formulas are shown here in infix notation instead of RPN (reverse Polish notation). Placeholder P1 receives all root pages W whose property “category” corresponds to the value “main.” Placeholder P2 potentially receives all root pages since the constant formula “true” applied to any root page W is evaluated as “true.” Placeholder P3 only receives root page W3 since the latter is the only one with the category “admin,” only this page has a property “password protected” and the property “password protected” is also “true” only for this page.

FIG. 4b shows for which placeholders the root pages come into consideration only on the basis of the criteria encoded in the Boolean formula. In this case, the priorities have not yet been considered. The final assignment additionally on the basis of the priorities is shown in FIG. 4c.

If the priorities of the placeholders are also factored in, the final assignment on the right side of FIG. 4c results. Root page W1 can basically be assigned to placeholder P1 and placeholder P2, but placeholder P1 has the higher priority. Root page W1 is thus assigned to placeholder P1. Root page W2 is assigned only to the placeholder P2 since only the formula of the placeholder P2 applied to root page W2 is evaluated as “true.” The placeholder P2 is thus also automatically the placeholder with the highest priority for root page W2. Root page W3 also remains assigned to the placeholders P2 and P3: For all placeholders with priority, only the formula in placeholder P2 is evaluated for root page W3 as “true.” Since placeholders without priority receive all root pages W for which the formula of the priority-free placeholder is evaluated as “true,” the assignment of root page W3 to placeholder P3 persists. In summary: The root page W1 is suitable for placeholder P1 and placeholder P2, but placeholder P1 has the higher priority (smaller value=higher priority). Therefore, root page W1 is only assigned to placeholder P1. Root page W2 and root page W3 are suitable for placeholder P2. Root page W3 is additionally suitable for placeholder P3 since placeholder P3 does not have a priority and thus receives all root pages with suitable criteria.

This thus calculated assignment of root pages W to placeholders P then takes place via the anchor points A described above.

The app 2 and its interaction with the measuring transducer 1 is briefly discussed below.

The loadable code of the app 2 is structured to be able to interact at two ends with the measuring transducer 1:
There are one or more interface methods 22 in the app 2 that the basic system 1 calls to retrieve a particular functionality in the app 2; example: calculation of measured values
The basic system 1 provides functions via one or more system calls 24a, which are called via system call stubs 24 within the app 2; example: access to data structures, sensor parameters, sensor configuration, or expanded computational methods.

The execution of the app 2 is denied if the system calls 24a or interface methods 22 are not present or are present only in an incompatible version or do not match the target system, i.e., the app 2 has been written for a wrong system. The app 2 is terminated if it tries during runtime to execute a system call 24a that is not present in the measuring transducer 1 or is present in an incompatible version.

The app 2 comprises at least program code with the app-specific menu structure MApp. The app 2 furthermore comprises metainformation 21. The metainformation 21 comprises properties of the root page W. A possible property is that the root page W is designed as an initial page, i.e., the measuring transducer 1 directly presents the root page W after the start (i.e., directly at the end of the boot process).

The metainformation 21 furthermore comprises, for example, at least the name and version of the app 2, the target system of the app 2, the name and version of expected system calls 24a, and the name and version of offered interface methods 22.

The app 2 is present, for example, in the form of an image file in which the actual program code, the identification feature 21 (metainformation) and the menu structure are located.

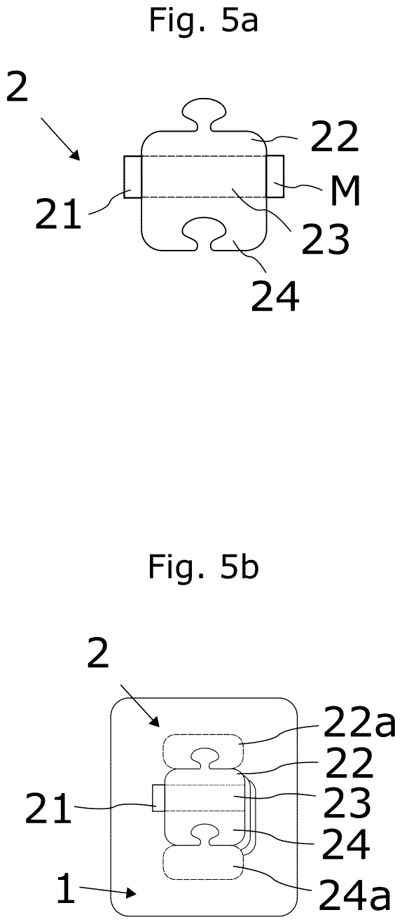

This is also shown by the general representation of the app 2 in FIG. 5a. The program code comprises three parts: the actual main logic 23, one or more interface methods 22 which are called by the measuring transducer 1, and one or more system call stubs 24 on the basis of which functions in the measuring transducer 1 are called. The metainformation 21 and the menu structure M are also shown symbolically here. For reasons of clarity, the menu structure M was omitted in FIG. 5b.

An app 2 can only run on the measuring transducer 1 if the app 2 offers the interface methods 22 that the measuring transducer 1 expects and the measuring transducer 1 offers the system calls 24a that the app 2 expects.

Interface methods 22 and system calls 24a represent interfaces between the app 2 and the measuring transducer 1. Since these are intended to be expandable over time in a downward compatible manner, the interfaces are to be versioned.

The code of the app 2 can consist of any algorithms.

The main logic 23 for an app, which provides for the use of a sensor, for example, can be designed, for example, to convert the raw values of the sensor into measured values. Raw values are the physical parameters such as a voltage value, while the measured value represents for example the fat content of milk or a concentration of a specific substance in the medium to be measured. Interface methods 22 are, for example, entry points for calculating the measured value. System calls 24 are, for example, optimized routines which are frequently used in signal processing algorithms and sensor functions in order to query the current raw values and determine the calculated measured value. The sensor can give the current raw values as parameters to the interface method 22 of the app 2, or the app 2 can query the current raw values of the sensor via an API. The app 2 accordingly forwards the measured values, possibly with the respective unit, for example as a return value.

FIG. 5b shows the relationship between the app 2 and the measuring transducer 1. As mentioned, a plurality of apps 2 can run simultaneously on the measuring transducer 1. This is illustrated by the puzzle parts lying under each other that are indicated in the middle of the drawing. In the measuring transducer 1, there are interface stubs 22a, on the basis of which the interface methods 22 in the app 2 are called. The measuring transducer 1 offers the app 2 functionalities in the form of system calls 24a. So that an app 2 can call the system calls 24a located in the measuring transducer 1, there are corresponding system call stubs 24 in the app 2.

As shown in FIG. 5b, a plurality of apps 2 can be run simultaneously, but all apps 2 for the same type have the same interfaces. In one embodiment, apps 2 run in an isolated environment in order to prevent a defective app 2 from causing the host to crash. Due to this isolation, the measuring transducer 1 cannot directly call a method in the app 2. The app 2 also cannot perform direct calls to the measuring transducer 1. Apps 2 also run in their own address space and by default cannot access data of the measuring transducer 1.

Instead, the process runs as shown in. In order to interact with an app 2, there are interface stubs 22a on the sensor side. An app 2 is only “entered and left” via the interface stubs 22a. If the measuring transducer 1 calls a stub 22a, a dispatch mechanism jumps into the app 2 and calls the corresponding interface method 22. The corresponding interface method 22 call the main logic 23, which executes its function and returns. The main logic 23 can also access system calls 24a. In this case, the main logic 23 calls a stub 24, and a dispatch mechanism in turn forwards a system call 24a on the basic system side. Now, execution again occurs in the measuring transducer 1, the system call 24a executes its action, then returns to the app 2, and the app 2 finally returns to the measuring transducer 1. The application code may consist of a main loop so that this cycle can be repeated indefinitely.

In one embodiment, the root page W does not represent a page in the sense mentioned above, but is designed as an interface method 22 in the app 2. This interface method 22 is then responsible for generating a corresponding app-specific menu structure together with root page W. Thus, the root page together with the properties does not have to be static information but can be calculated in part.

System calls 24a are implemented on the measuring transducer 1 and provide functions to the apps 2. For example, the measuring transducer 1 can provide methods for reading or writing particular memory regions via system calls 24a. System calls 24a are defined by a versioned interface specification. The same thing applies to the methods of the system calls 24a per se as to an interface method 22.

The measuring transducer 1 must be able to load and execute apps 2, for example by the sensor firmware implementing a virtual machine in which apps 2 are interpreted/executed. The virtual machine is designed as an interpreter, such as an emulator, as an ahead-of-time compiler, just-in-time compiler, hypervisor, or a combination thereof. The CPU architectures of host and guest (app 2 running thereon) do not necessarily have to be the same in this case. In the case of hypervisors, however, it is advisable for a performing embodiment of the app to select the same CPU command set.

In the embodiment as a virtual machine, inherent measures for memory protection, and thus also security, are obtained. A possible malicious code cannot reach beyond the virtual machine and, as a result, cannot negatively affect the firmware or other virtual machines that are running (a plurality can run in parallel, see below). There is a separation between the different virtual machines, because no common memory regions are used. The different virtual machines interact only via defined interfaces, so that only limited functions can be executed thereby. The virtual machine, in its embodiment as an interpreter (emulator), forms an environment for executing the app in the form of a virtual CPU with a virtual address space. This system is, in this case, isolated from the rest of the system, i.e., from the host system, i.e., from the firmware of the sensor. If an app is defective, it does not affect the rest of the system. The rest of the system continues to run, even if the defective extension crashes. Communication is carried out via defined interfaces.

However, the app 2 can also be run “natively” on the basic system 1. For this purpose, the measuring transducer 1 comprises, for example, an ahead-of-time compiler or a just-in-time compiler. The app 2 is present in a corresponding format on the basic system 1.

If emulation does not take place via a virtual machine (see above) and the CPU architectures of host and guest match, support of the processor of the measuring transducer 1 is necessary to execute the app; e.g., a memory management unit (MMU) is then needed in hardware so that the memory protection can be realized.

For apps 2 to be interpreted/run, the app 2 must contain program code that is interpretable/runnable, or that can be converted into an interpretable/runnable form, for example machine-independent byte code. Likewise, the program must be stored in a binary format, for example in the executable and linking format (ELF). The binary format provides information about the memory layout of the app, e.g. the position and size of the code and data. This information is necessary for loading an app 2 and for preparing it to run.

The program code can be executed via an interpreter (virtual machine) or can be translated before execution into the machine code of the processor used on the basic system (compiler).

1. A method for creating a menu structure on a measuring transducer of process automation technology, comprising the steps of:
transmitting an app to the measuring transducer;
wherein the firmware of the measuring transducer is designed to receive and store apps;
wherein the app comprises at least program code with an app-specific menu structure;
wherein the app-specific menu structure comprises at least one root page as the top hierarchical menu page; and
combining the app-specific menu structure with a measuring-transducer-specific menu structure to form a common menu structure, wherein the measuring-transducer-specific menu structure is located in the measuring transducer, using a placeholder, which comprises one or more anchor points, wherein the placeholder defines where the app-specific menu structure is integrated into the measuring-transducer-specific menu structure;
wherein the anchor point comprises a reference to the root page and the entire app-specific menu structure is integrated thereunder.

2. The method according to claim 1,
wherein the anchor point is designed as a tuple comprising the title of the root page or the title of the app, and a reference to the root page.

3. The method according to claim 1,
wherein the root page is displayed directly after the start of the measuring transducer.

4. The method according to claim 1,
wherein the app comprises metainformation about properties of the root page.

5. The method according to claim 4,
wherein the metainformation declares a root page as the home page.

6. The method according to claim 4,
wherein the measuring transducer mounts the app-specific menu structure on the basis of the metainformation at a particular location in the measuring-transducer-specific menu structure.

7. The method according to claim 1,
wherein the app-specific menu structure comprises an explicit reference to the measuring-transducer-specific menu structure, and a jump from the app-specific menu structure into the measuring-transducer-specific menu structure is thus enabled.

8. The method according to claim 1,
wherein a switch can take place from the app-specific menu structure, or an app-specific menu structure in the presence of a plurality of app-specific menu structures, into the measuring-transducer-specific menu structure or into another app-specific menu structure and in each case back, wherein the respective exit point is temporarily stored and the switch back takes place exactly to this location.

9. The method according to claim 1,
wherein user inputs via the operating elements of the measuring transducer are forwarded to the app, whereby interaction with the presented menu content can likewise be controlled by the app program code.

10. The method according to claim 1,
wherein the measuring transducer provides interfaces, whereby the app presents the app-specific menu structure on a display of the measuring transducer.

11. The method according to claim 1,
wherein the measuring transducer comprises a plurality of apps,
wherein each app comprises its own program code with its own app-specific menu structure,
wherein each app-specific menu structure is integrated under a separate anchor point.

12. The method according to claim 1,
wherein the integration of the app-specific menu structure through the anchor point into the measuring-transducer-specific menu structure takes place on the basis of predefined criteria.

13. The method according to the claim 12,
wherein the criterion is applied on the basis of a Boolean formula.

14. The method according to claim 1,
wherein an app is mounted at a plurality of anchor points.

15. A measuring transducer for executing a method of creating a menu structure, comprising:
a data processing unit with a memory configured for executing the steps of:
transmitting an app to the measuring transducer;
wherein the firmware of the measuring transducer is designed to receive and store apps;
wherein the app comprises at least program code with an app-specific menu structure;
wherein the app-specific menu structure comprises at least one root page as the top hierarchical menu page; and
combining the app-specific menu structure with a measuring-transducer-specific menu structure to form a common menu structure, wherein the measuring-transducer-specific menu structure is located in the measuring transducer, using a placeholder, which comprises one or more anchor points, wherein the placeholder defines where the app-specific menu structure is integrated into the measuring-transducer-specific menu structure;
wherein the anchor point comprises a reference to the root page and the entire app-specific menu structure is integrated thereunder.

16. The measuring transducer according to claim 15, includes an operating element designed to switch back and forth between the different menu structures without actually leaving the menu structure of the app.
